(19) United States
(12) Patent Application Publication
(10) Pub. No.: US 2020/0394721 A1
(43) Pub. Date: Dec. 17, 2020

(54) SYSTEMS AND RELATED METHODS FOR INFORMATION PRESENTATION FOR INDEPENDENT CONTRACTORS

(71) Applicant: VAULTZ, INC., Columbus, OH (US)

(72) Inventors: Richard C. GONZALEZ, New Albany, OH (US); Riccardo l. GRASSESCHI, Westerville, OH (US); Gregory S. HEIS, Galena, OH (US); Kenneth ANDRULIS, Jr., Galena, OH (US)

(73) Assignee: VAULTZ, INC., Columbus, OH (US)

(21) Appl. No.: 16/964,114

(22) PCT Filed: Jan. 23, 2019
(86) PCT No.: PCT/US2019/014729

§ 371 Date: Jul. 22, 2020

Related U.S. Application Data
(60) Provisional application No. 62/621,115, filed on Jan. 24, 2018.

(51) Int. Cl. G06Q 40/00; G06Q 40/02; G06Q 20/32; H04L 9/32

(52) U.S. Cl. CPC G06Q 40/10; G06Q 40/123; G06Q 40/02; H04L 2209/56; H04L 9/3213; G06Q 2220/00; G06Q 20/3221

(57) ABSTRACT

Information presentation for independent contractors. The various embodiments include a product and system that eases the burden of analyzing income, assessing tax liability, creating tax set-asides for independent contractor tax payments, and visually conveying the information to a user. The example embodiments provide a technical solution to a technical problem of calculating and presenting tax set-aside advice contemporaneously as deposits are made to the user's bank account. Example embodiments may automate creating set-asides for tax payments. The technical solutions enhance the readability and visibility of financial data on the smaller screens of mobile devices.

### CROSS-REFERENCE TO RELATED APPLICATIONS

This application claims the benefit of U.S. Provisional Application Ser. No. 62/621,115 filed Jan. 24, 2018. The provisional application is incorporated by reference herein as if reproduced in full below.

### BACKGROUND

Every year the Internal Revenue Service (IRS) in the United States fails to collect a portion of taxes that are due to the United States treasury. This “tax gap” is currently estimated to be $450 billion dollars annually. According to the IRS, the number one contributor to the tax gap is the failure of independent contractors and self-employed individuals to properly report and manage their tax responsibilities. Other countries and taxing authorities face similar issues.

The United States has the highest tax compliance rate (84.4%) of any other country, which points the problem away from purposeful avoidance and towards a systemic process shortcoming. The difficulties faced by independent contractors and the self-employed arise from several factors, including their lack of a predictable income, appropriate estimating knowledge, and mechanisms to remove funds from day-to-day cash flow. These problems are not felt by the majority of workers where state-of-the-art accounting processes ensure that their employers automatically maintain appropriate tax withholdings. This management difficulty of the self-employed may have, at one time, been confined to the realm of dedicated professional service workers who often employed accountants to keep things manageable; however, in recent years the difficulty has spread to all sectors of the workforce.

The growth of the “gig economy” in the United States and throughout the world is likely compounding the problem and will continue to increase the tax gap, as participants in the increasing number of independent contractor opportunities are skewing younger in age with less experience managing tax liabilities. The millennial generation's inclination to not work for “brick and mortar” businesses and opportunities created by changes in health care coverage laws are factors that will continue to drive up independent contractor engagements, leading to more tax reporting and compliance issues. This is a problem not only felt by agencies responsible for collecting tax revenue, but also can be deeply troubling for young taxpayers.

### SUMMARY

The various embodiments disclosed herein are directed to systems and related methods for information presentation for independent contractors. The technical solutions including not only enhancing the readability and visibility of financial data presented on the smaller screens of mobile devices, but also technical solutions to the technical problem of calculating tax set-aside advice contemporaneously as deposits are made to the user's bank account. Example embodiments automate creating set-asides for tax payments, giving the user a similar experience to an employee of an established business. The systems and methods also vastly improve the taxpayer's experience in dealing with estimated tax payments, which will ultimately help lower the tax gaps in the United States and elsewhere.

### BRIEF DESCRIPTION OF THE DRAWINGS

For a detailed description of example embodiments, reference will now be made to the accompanying drawings in which:

FIG. 1 shows a block diagram of a system in accordance with at least some embodiments;

FIG. 2 shows a block diagram of the system in greater detail, and in accordance with at least some embodiments;

FIG. 3 shows an annotated process diagram in accordance with at least some embodiments;

FIG. 4 shows user interfaces in accordance with at least some embodiments;

FIG. 5 shows example user interfaces in accordance with at least some embodiments;

FIG. 6 method in accordance with at least some embodiments; and

FIG. 7 shows a computer system in accordance with at least some embodiments.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to. . . . ” Also, the term “couple” or “couples” is intended to mean either an indirect or direct connection. Thus, if a first device couples to a second device, that connection may be through a direct connection or through an indirect connection via other devices and connections.

“Completed days within a current tax year” shall mean a number including the current day (partially completed (e.g., today)) and all previous days within the current tax year. For example, if the current day is January 31^{st} and the tax year is the calendar year, then on the January 31 “completed days within the current tax year” shall mean 31 days.

“Percentage completion of the current tax year” shall mean completed days within the current tax year expressed as percentage. For example, completed days within the current tax year divided by total days of the current tax year multiplied by 100.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments disclosed herein are directed to systems and related methods for information presentation for independent contractors. In particular, various embodiments are directed to systems and related methods for designating deposits as taxable income, estimating tax burden, and setting aside tax payments, such as for independent contractors. More particularly, various embodiments provide technical solutions to problems such as differentiating deposits in a user's primary bank account that are not taxable income from deposits that are taxable income. Moreover, various embodiments provide technical solutions to the problems of calculating tax liability and setting aside funds to meet periodic tax payments (e.g., quarterly in the United States, biannually in other countries) for independent contractors who may be paid at irregular intervals, and/or from a variety of sources. Before proceeding with the various embodiments, related-art methods are described.

Point-in-Time Accounting

Most income taxing systems throughout the world operate based on a tax year, usually aligned with the calendar year. In spite of the total tax due being based on a complete tax year of income and expenses, most revenue collection agencies also require periodic estimated tax payments to be made. In the United States, for example, the Internal Revenue Services (IRS) requires tax payers to make quarterly estimated tax payments. Failure to make periodic estimated tax payments can result in substantial penalties, in some countries approaching 50%.

Related-art techniques for calculating periodic estimated tax payments have several drawbacks. In particular, related-art techniques for making periodic estimated tax payments most often occur at a single point in time. For example, in the United States the tax payer may calculate and pay quarterly estimated tax payments once per quarter. More particularly still, related-art techniques involve, just prior to the end of quarter, collecting data regarding income over the quarter, estimating tax, and making the estimated tax payment for the quarter to the IRS. The process continues once each quarter, with the end-of-tax-year reconciliation at tax time. The related-art process has several shortcomings. For example, when dealing with a quarter's worth of data (either paper or electronically), it is easy to overlook taxable income. Another issue is that the assessment regarding tax due is only performed once a period, and many times the taxpayer will have spent a majority or all the income that is taxable income, leaving no or insufficient funds to cover the overall tax liabilities. Moreover, a young taxpayer with little or no tax payment history may not even realize that periodic estimated tax payments are required for independent contractors.

Continuous Processing

Unlike related-art techniques, in the various embodiments disclosed herein the analysis of the tax situation is performed continuously. More particularly, in example embodiments the tax analysis is performed contemporaneously with each new deposit of taxable income. Performing the tax analysis with each new deposit moves the assessment and payment of periodic estimated tax payments from “Point-in-Time” accounting practices (where mistakes in estimation and savings shortfalls happen) to a continuous cycle of projections and estimations that better ensure appropriate tax set-asides are collected and paid. The continuous cycle is a benefit to the independent contractors in that they are given an experience similar to an employee where taxes are assessed and tax set-aside automatically and with more visibility. With continuous processing of payments and projection of income and taxes, the various embodiments ease the burden on the independent contractor as the embodiments reduce the need to compile accounting data and help ensure that appropriate tax set-asides are being considered during the course of the tax year. The various example embodiments were developed in the context of periodic estimated tax payments in the United States, and the description that follows is based on the developmental context; however, the description and developmental context shall not be read as a restriction the applicability of the various embodiments. Indeed, the many taxing authorities (e.g., cities, counties, states, and countries) expect periodic estimated tax payments to be made, and the various embodiments are applicable to any such taxing authority, including multiple simultaneous taxing authorities. The description now turns to an example system to orient the reader.

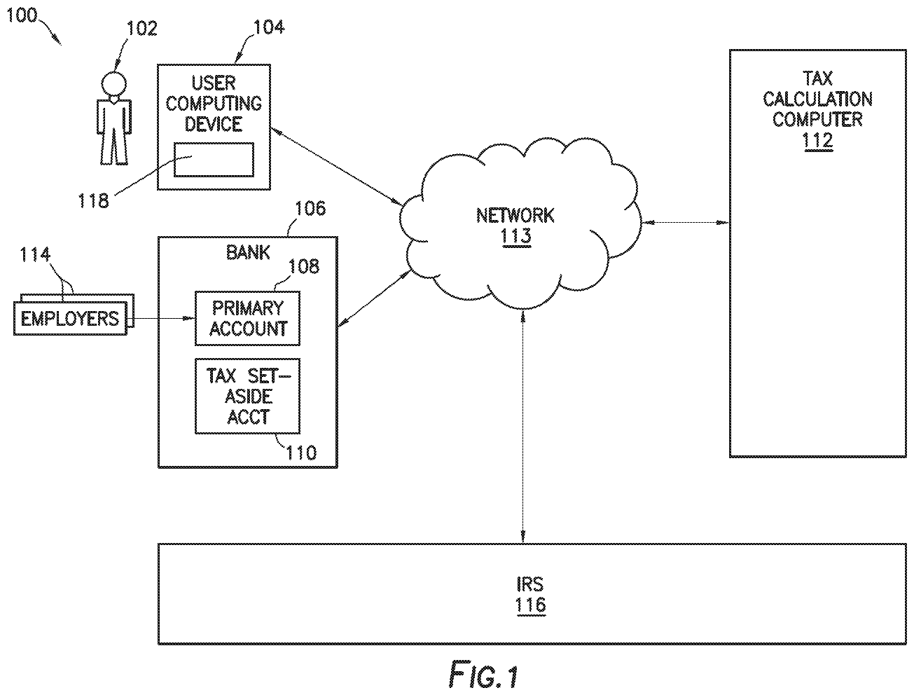

FIG. 1 shows a block diagram of a system in accordance with at least some embodiments. In particular, FIG. 1 shows an example system 100 comprising a user 102 that has computing device, the computing device illustrative shown as a user computing device 104. The user 102 discussed herein works as an independent contractor, such as a sole proprietor or owner of legal entity that operates as a pass-through entity for tax purposes. For example, the user 102 may work as driver for any one of a variety of ride share services (e.g., Uber, Lyft), or the user 102 may work as an independent software developer, to name just a few. The user computing device 104 may take any suitable form, such as, mobile computer, laptop computer, smart phone, or tablet device. An interface program 118 executes on the user computing device 104.

The user 102 in the existing system has a relationship with bank 106. In particular, the user 102 may have one more accounts open with the bank, such as primary account 108 and tax set-aside account 110. In accordance with example embodiments, the user 102 may access the accounts electronically, such as by using the user computing device 104 communicating through a digital communication network 113 (such as the Internet). In some cases, portions of the communication pathways between the user computing device 104 and the bank 106 may be by wireless, but such connections are not shown so as not to unduly complicate the figure.

Because the user 102 works as an independent contractor, taxable income provided from multiple employers 114 of the user 102 may be deposited into the primary account 108 of the user 102 without withholding any income or social security taxes (as would be the case if the user 102 was a regular employee). The deposits into the primary account 108 of the user 102 may take any form, such as the user 102 depositing a check, or some form of electronic funds transfer directly to the primary account 108.

The example system 100 further comprises a second computer illustratively labelled tax calculation computer 112. The tax calculation computer 112 communicatively couples to both the user computing device 104 and the bank 106 (including accounts 108 and 110) by way of the example network 113. The tax calculation computer 112 may take any suitable form, such as server, a single computer system, a group of computer systems working in concert, or any of a variety of cloud computing scenarios where the location and identity of the tax calculation computer 112 may vary day-to-day or depending processing load of programs that implement the various example methods disclosed herein. The tax calculation computer 112 is communicatively coupled to the interface application 118 by way of the network 113, and in some cases the user computing device 104 (and interface program 118 thereon) may be located more than a mile from each other.

The example system 100 further comprises a computer system of a revenue collection agency, illustrative shown as IRS 116. The IRS 116 communicatively couples to any or all the remaining components of the system by way of the example network 113. The IRS 116 not only receives periodic estimated tax payments, but may also be a repository for tax information, such as tax bracket percentages, late fees, and the like. Computer systems within the overall systems 100 access the IRS 116 is several forms. For example, the tax calculation computer 112 may access the IRS 116 to determine tax bracket percentages, and the like. Computer systems of the bank 106 may make electronic funds transfers directly, or through intermediaries, to the IRS 116 to facilitate periodic estimated tax payments.

Still referring to FIG. 1, in an example system the user 102 interfaces with the user computer device 104 to communicate with the tax calculation computer 112. The interaction will be discussed in greater detail below, but for now assume that by way of the interaction the tax calculation computer 112 is provided access to the accounts 108 and 110 of the user 102 within the bank 106. The tax calculation computer 112, and more particularly programs executed by the tax calculation computer 112, access the primary account 108 of the user over the network 113. Based on the access, the tax calculation computer 112 identifies new deposits in the primary bank account 108. The tax calculation computer 112 analyzes the new deposits. Any new deposits representing taxable income are designated as such. The specification discusses in greater detail below examples of the analysis and designation process. Based on a new deposit designated as taxable income, the tax calculation computer 112 estimates an annual income, and in some embodiments recommends to the user a tax set-aside value, the recommendation by way of a message sent to the user computing device 104. In some cases, and as discussed more below, the tax calculation computer 112 may interact with the bank 106 to cause the recommended amount to be transferred from the primary account 108 to the tax set-aside account 110. Moreover, if the period for the periodic estimated tax payment is coming to a close, the tax calculation computer 112 may work with the bank 106 to electronically transfer the funds from the tax set-aside account 110 to the IRS 116 either directly or through an intermediary. The example systems recursively perform the identification of new deposits, designation of certain of the new deposits as taxable income, estimation of annual income based on the designated new deposits, and recommendation of tax set-asides. The specification now turns to a description of the system in greater detail.

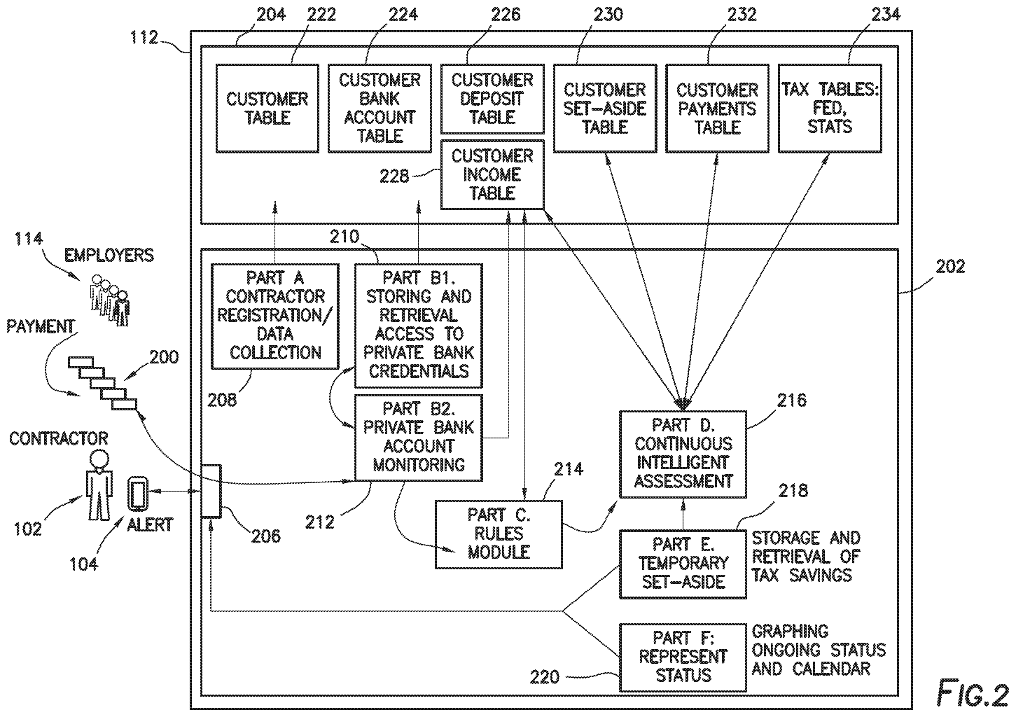

FIG. 2 shows a block diagram of the system, with some components shown in greater detail, and other components omitted. In particular, visible in FIG. 2 is the user 102, as well as the user computing device 104. The user 102, through the user computing device 104, is communicatively coupled to the tax calculation computer 112 (though the intervening networks are omitted for clarity). FIG. 2 further shows example employers 114 making payments to a plurality of user accounts 200, which user accounts include the primary account 108 (FIG. 1) of the example user 102. The tax calculation computer 112 is communicatively coupled to the user accounts 200 (again though the intervening networks are omitted for clarity).

The tax calculation computer 112 comprises various hardware and software components designed and constructed to implement the various embodiments discussed herein. The example system comprises various software routines 202 communicatively coupled to a database 204. The software routines may be programmed in any suitable language and executed on any suitable hardware platform. In one example system the software routines 202 are written in Java, and thus the tax calculation computer 112 may comprise, in whole or in part, a scalable Java application server (e.g., executed in the cloud). Other programming languages, and other hardware platforms, may be equivalently used. The example database 204 may be any suitable database (e.g., a relational database) executed on any suitable hardware platform.

Still referring to FIG. 2, software routines 202 may be conceptually, though not necessarily physically, divided into a plurality of modules or components. In particular, the software routines 202 may include a web services interface 206 that facilitates communication to and from external devices, such as the user computing device 104, or the user accounts 200 at one or more banks 106 (FIG. 1). The software routines 202 may further include: Part A, contractor registration and data collection module 208 (hereafter just data collection module 208); Part B1, storing and access to private bank credentials 210 (hereafter just credentials module 210); Part B2, private bank account monitoring (hereafter just account monitoring module 212); Part C, rules module 214; Part D, continuous intelligent assessment module 216 (hereafter just assessment module 216); Part E, temporary set-aside module 218 (hereafter set-aside module 218); and Part F, representative status module 220 (hereafter just status module 220). The various modules will be discussed in greater detail after the introduction of various components the example database 204.

The example database 204 stores and provides access to several pieces of information. The example database 204 can be conceptually, though not necessarily physically, divided into a plurality of tables including: a customer table 222 that stores information about customers of the systems, such as user 102; customer bank account table 224 that stores information used to access the user accounts 200 (such as primary account 108 (FIG. 1)); customer deposit table 226 that stores information regarding deposits in the user account 200; customer income table 228 that stores information about taxable income of the customers; customer set-aside table 230 that stores information about tax set-asides of each customer; customer payments table 232 that stores information about periodic tax payments made by the customers; and tax tables 234 that stores information regarding tax rates for various taxing entities. The specification now turns to a more detailed description of each of the example modules. The following description is based on the user 102 as the customer, but the description applies to each customer of the tax calculation and computer 112.

Part A—Data Collection Module

The example systems and methods utilize fixed-state data, such as: the user's filing and deduction choices; any existing set aside and earnings unaccounted for within the database; and personal information to be included with payments. The data is stored within the database 204 which associates it with the payment and savings data described in Parts B-F (discussed more below). Database storage is helpful in this instance as the system is able to independently evaluate millions of records at a time in order to process tax set-aside recommendations for the large number of customers of the platform.

In example embodiments, the data collection module 208 communicates with the user 102 through the example web services interface 206. Based on the communication, the data collection module 203 gathers the noted information about the user 102 and stores the information in the database 204, such as in the customer table 222.

Part B1—Credential Module

In order to evaluate the user's new deposits, example embodiments utilize secure, delegated access to the user's 102 primary account 108 (FIG. 1). In example embodiments access to the primary account 108 is achieved by asking user 102 to login into the private bank account and, in the process, the example system securely stores the user's credentials. An example system does not store the credentials in plain text; but rather, the example system maps the stored credentials to a secure token used for regular access. With the token, the system is able to access all account data and transactions. In some example systems, access to the user's accounts is provided by way of a third party vendor, such as the services provided by Plaid Inc. (www.plaid.com) of San Francisco, Calif.

Thus, the example credential module 210 may receive login credentials to a first bank account at a bank of the user 102, the receipt from user 102 by way of the user computing device 104 and the web services interface 206. The credential module 210 may store the login credentials in the customer bank account table 224, in some cases as an encrypted token. Thereafter, the software routines 202 may use the bank account information, such as the encrypted token, to access a third party service that acts as an intermediary to the primary account 108 (FIG. 1) at the bank.

Part B2—Account Monitoring Module

In the example systems and methods, the software routines periodically (e.g., daily, multiple times each day) polls the accounts of user 102 looking for new transactions of the primary account. The example systems and methods may poll for new transactions using two mechanisms. Stored procedures are executed in batch mode for each account in a queue. These stored procedures traverse the account (e.g., by way of an Open Financial eXChange (OFX) interfaces) and gather all transaction data. In the example systems, the transaction data is passed to a secure web Uniform Resource Locator (URL, the listener) as Java Script Open Notation (JSON) data. The listener executes the transaction rules which process the transactions according to the deposit rules processing described below (Part C—deposit rules module 214). Alternatively, the listener can also execute its own pull requests to primary accounts of the customers by using the secure tokens and process transactions on demand. The direct pull procedure is useful to mitigate failures in data transfers from the first process described.

Integrating with the primary account eliminates the hurdle of variation in each user's pay rate and timing. With the ability to analyze all of the user's 102 transactions, it is no longer necessary to manage the information that would have been necessary to understand income sources and payments. In addition, and as discussed more below, this integration enables the system to move money on behalf of the worker for set asides and eventual payments to the revenue collection agency.

Part C—Deposit Rules Module 214

After connecting to, viewing, and downloading some or all the bank transactions as described in Part B2, the example systems and methods turn to determining the types of new transactions. As the system is attempting to recognize deposit transactions, in example cases all of the account transactions are processed through a rules system that looks for positive values on the amount fields within the data. Identifying positive values may be accomplished by processing all of the data into an array and using recursion to find positive values in the data. In addition, when positive values are encountered the recursion algorithm locates and saves any description or vendor information associated with the individual transaction for further rules processing.

Some example systems identify new deposits as taxable income based on an ability to identify and store known employers 114 (payers in the context of a deposit into the user's account). Identifying employers may take many forms. In one example the user 102 identifies each employer. In particular, the user 102 is shown each new deposit transaction on the user computing device 104, and the user 102 identifies employers by interaction with the user computing device 104. By selecting the transaction and a prompt to create the rule, the user 102 designates the transaction as taxable income, and future deposits made by the identified employer are automatically designated as taxable income for further processing (discussed more below).

In addition to, or in place of user identified employers, the employers themselves may self-designate. For example, a partnering employer can pre-set the payer field of an electronic funds transfer to a predetermined description so that any payment made by the employer is understood by the example systems and methods to be taxable income to the user. Further still, identification of an employer may be based on identified employers of other users (e.g., crowd-sourced identification). In particular, the example processing rules identify names of employers designated by other users using the system. Identifying the employer by crowd sourcing may be accomplished by running and sorting by submission counts, queries over the name fields within the database 204 which have been previously submitted by either user identified employers or employer submitted fields. With crowd-sourced approach, the example system gets smarter over time and requires less and less user interaction.

The rules described above regarding identifying employers are stored within the database 204 (e.g., in the customer deposit table 226, the customer income table 228, or other table dedicated specifically to rules storage) and such rules may be used in subsequent analysis of whether new deposits are taxable income. This data storage and rules processing may be accomplished by way of computation and relational storage to increase utility. For each new deposit determined to be and designated as taxable income, the system then utilizes Part D (described below) to make tax and tax set-aside assessments.

Part D—Assessment Module 216

The assessment module 216 of the example embodiments calculates or generates a recommended tax set-aside value for each new deposit designated as taxable income by the deposit rules module 214. In particular, the assessment module 216 may communicatively couple to the rules module 214, the customer income table 228, the customer set-aside table 230, the customer payments table 232, and the tax tables 234. New deposits designated as taxable income trigger the assessment and processing of the unique method to determine and recommend a tax set-aside value for the new deposit.

In particular, for each new deposit designated as taxable income, the example assessment module 216 may calculate a year-to-date income value (hereafter just “new income value”) by summing the new deposit and all previous deposits indicated as taxable income in the current tax year. The data for the calculation may come in whole or in part from the customer income table 228. With the new income value, the example embodiments project an annual income based on the new income value. In some cases, the annual income is determined by calculating an average periodic income, and multiplying the average periodic income by a number of periods within the current tax year. The example embodiments then calculate or project an annual tax burden of the projected annual income. That is, for example, using the tax tables 234 the example embodiments calculate an annual tax burden based on the projected annual income. Next, the example embodiments project a remaining tax burden based on previous tax payments for the current tax year and a value in the tax set-aside account (e.g., subtract the previous tax payments for the current tax year and a value in the tax set-aside account from the annual tax burden). Next, the example embodiments calculate an expected future income value (e.g., the difference between the annual income value and the new income value). Thereafter, the example embodiments may calculate an adjusted set-aside percentage based on the remaining tax burden and the expected future income, and recommend a tax set-aside value of the new deposit based on the adjusted set-aside percentage and the new deposit.

The granularity of the period used to calculate the average periodic income may be any suitable period, such as calendar quarter, month, day, hour, half-hour, minute, and so on. The inventors of the present specification have found that smaller periods provide better accuracy over the course of a tax year, but periods smaller than about a day provide diminishing improvements in accuracy.

Consider the following numerical example. That is, consider the following: the tax year is the calendar year; the tax rate is flat 10%; the period used for calculation is a day; previous deposits designated as taxable income in the tax year total $90,000; and $9000 was previously paid to the IRS and/or resides in the user's tax set-aside account. Next consider that a new deposit on July 1st (e.g., 182 days into the (non-leap) tax year) of $10,000 has been designated as taxable income. In the example method, the new income value is thus $100,000 ($90,000 plus $10,000), the average daily income is thus $549.45 ($100,000 divided by 182), and the projected annual income is thus $200,549.25 ($549.45 times 365 days). With the projected annual income of $200,549.25, the annual tax burden in this example would be $20,054.93. Next, the example methods calculate or project the remaining tax burden as $11,054.93 ($20,054.93 minus $9000). The expected future income within the current tax year is thus $100,549.25 ($200,549.25 minus $100,000), and the adjusted set-aside percentage is thus 11% ($11,054.93 divided by $100,549.25 times 100). The recommended tax set-aside value of the new deposit is thus $1,100 ($10,000 times 11%).

In some cases the user 102 may know in advance how much taxable income can be expected over the course of the year. In fact, the user 102 may only work an amount to achieve a certain amount of taxable income. Consider, as an example, that user 102 expects to work only the first half of the year and have $100,000 of taxable income, and then expects to travel or other endeavors the second half of the year making no income. To capture such a situation and more accurately determine expected tax burden, in some cases the user 102 may provide to the system an estimated annual income (e.g., at Part A—data collection module 208 and stored in the customer table 222). During the portion of the example method discussed regarding projecting an annual income, the tax calculation computer 202 (e.g., the assessment module 216) may replace or override the projected annual income with the estimated annual income, and continue the processing accordingly.

The description to this point has implicitly assumed that the user 102 has dutifully paid periodic estimated tax payments when due, and further has dutifully set-aside recommended values for estimated tax not yet paid the IRS. However, for reasons related to cash flow timing, in some cases the user 102 may not have paid sufficient periodic estimated tax payments and/or set aside values. Nevertheless, the example systems, in considering payments actually made to the IRS in the tax year and current amounts in the tax set-aside account, may recommend increased set-aside values to cover previous shortfalls as part of the normal process.

Consider the following modified numerical example. That is, consider the following: the tax year is the calendar year; the tax rate is flat 10%; the period used for calculation is a day; previous deposits designated as taxable income in the tax year total $90,000; and nothing has been was previously paid to the IRS and/or and nothing resides in the user's tax set-aside account. Next consider that a new deposit on July 1st (e.g., 182 days into the (non-leap) tax year) of $10,000 has been designated as taxable income. In the example method, the new income value is thus $100,000 ($90,000 plus $10,000), the average daily income is thus $549.45 ($100,000 divided by 182), and the projected annual income is thus $200,549.25 ($549.45 times 365 days). With the projected annual income of $200,549.25, the annual tax burden in this example would be $20,054.93. Next, the example methods calculate or project the remaining tax burden as $20,054.93 ($20,054.93 minus $0 (nothing previously paid or set aside)). The expected future income within the current tax year is thus $100,549.25 ($200,549.25 minus $100,000), and the adjusted set-aside percentage is thus 19.95% ($20,054.93 divided by $100,549.25 times 100). The recommended tax set-aside value of the new deposit is thus $1,995 ($10,000 times 19.95%). The adjusted set-aside percentage is recalculated for each new deposit designed as taxable income, and each recalculation takes into account projected annual income, as well as previous estimated tax payments and value in the user's set-aside account.

Expense Deductions

The various embodiments discussed to this point have dealt exclusively with new deposits designated as taxable income and recommended tax set-aside values for each new deposit as if the user 102 had no deductible business expenses that reduce taxable income. In some situations, using the amount of each new deposit as taxable income as the taxable amount may be sufficient for the user (e.g., a programmer who has very few deductible business expenses). However, in other cases the user 102 working as an independent contractor may have many deductible business expenses that reduce taxable income, and thus reduce the recommended tax set-aside values. For example, consider user 102 working as an independent over-the-road trucker. The user 102 may have deductible expenses in the form of fuel, tires, oil changes, registration, repairs, and the like. Thus, in accordance with at least some embodiments the example tax calculation computer 112 assists the user 102 in identifying deductible business expenses, and in turn reducing the estimated income values and corresponding estimated taxes.

Returning briefly to consider the rules module 214. After connecting to, viewing, and downloading some or all the bank transactions as described in Part B2, the example systems and methods turn to determining the types of new transactions. The system thus not only attempts to recognize deposit transactions, but also in example cases the account transactions are processed through an expense rules system that looks for negative values on the amount fields within the data. Identifying negative values may be accomplished by processing all of the data into an array and using recursion to negative values in the data. In addition, when negative values are encountered the recursion algorithm locates and saves any description or other information associated with the individual transaction for further expense rules processing.

Identifying expenses may take many forms. In one example the user 102 identifies each expense as a deductible business expense. In particular, the user 102 is shown each expense found by way of the user computing device 104, and the user 102 identifies expenses by interaction with the user computing device 104. By selecting the transaction and a prompt to create the rule, the user 102 designates the transaction as a deductible business expense, and future such expenses may be automatically designated as reducing taxable income for further processing.

In addition to, or in place of user identified business expenses, identification of an expense as a deductible business expenses may be based on identified business expenses of other users (e.g., crowd-sourced identification). In particular, the example processing expense rules identify names of entities designated by other users as deductible business expenses. Identifying deductible business expenses by crowd sourcing may be accomplished by running and sorting by submission counts, queries over the name fields within the database 204 which have been previously identified as deductible business expenses. With crowd-sourced approach, the example system gets smarter over time and requires less and less user interaction.

The example expense rules described above may also be stored within the database 204 (e.g., in the customer deposit table 226, the customer income table 228, or other table dedicated specifically to expense rules storage) and such rules may be used in subsequent analysis of whether new expenses reduce taxable income. This data storage and expense rules processing may be accomplished by way of computation and relational storage to increase utility.

Still considering situations where the tax calculation computer 112 considers deductible business expenses, the assessment module 216 may calculate or generates a recommended tax set-aside value for each new deposit designated as taxable income and each new expense designated as a deductible business expense since the last calculation. In particular, for each new deposit designated as taxable income, the example assessment module 216 may calculate a new income value by summing the new deposit and all previous deposits indicated as taxable income, and reducing the new income value by each deductible business expense.

Part E—Set-Aside Module 218

Still referring to FIG. 2, part of determining the tax set-aside for each new deposit designated as taxable income (and possibly deducible business expenses) is the amount already in the user's 102 tax-set aside account. As payments to user 102 working as a contractor are irregular in nature, there are fluctuations in the projected annual income that vary the recommended tax set-aside value. The example set-aside module 218 provides the balance of the tax set-aside account 110 (FIG. 1) to the assessment module 216 by accessing either or both of the account directly, or by reading from the various tables of the database 204.

In example systems, the recommended tax set-aside value associated with the new deposit is communicated to the user 102 by way of the user computing device 104. In some embodiments, it is the responsibility of the user 102 to move the funds from the primary account 108 (FIG. 1) to the tax set-aside account 110 (FIG. 1). In other cases, however, the system may automatically transfer funds between the accounts using the access information previously provided by the user (discussed in relation to the Part B1 credential module 210). In particular, the example set-aside module 218 may also be responsible for the movement of funds from the user's 102 primary account 108 (FIG. 1) to the tax set-aside account 110.

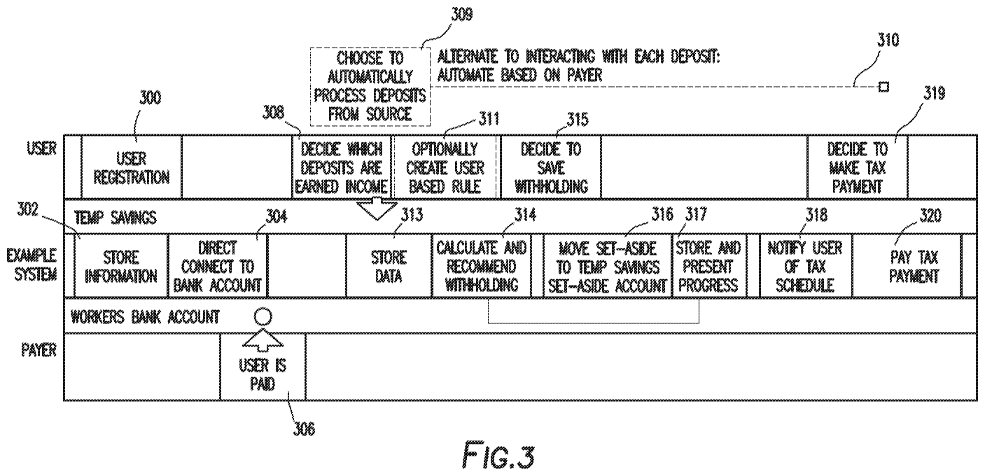

FIG. 3 shows an annotated process diagram in accordance with at least some embodiments. In particular, FIG. 3 has three rows: the upper-most row delineating actions of the user; the middle row delineating actions of the example system; and the bottom row delineating actions of the user's contract employers (payers in the figure). At 300, during user registration the example system collects the user's information used to access the primary bank account where payments are made for contractor work, the user's tax filing information, and the personal information to make payments to the revenue collection agency. At 302, the example system securely stores the user's information which is used to calculate and project the user's annual income and tax burdens. At 304, a direct connection to the user's primary bank account “listens” for all transactions to the primary bank account. Each deposit that is made from an outside source is recorded to present to the worker as a source of income. In some cases, each expense is recorded to present to the worker as a possible deductible business expense. The approach to listening can be both a pull request which regularly queries for deposits and payments, or a push where the banking system sends data directly to example systems. At 306, the user is paid in any paper or electronic method. Because the system “listens” to the user's account, the example system identifies payments made by check, cash, PayPal, or other direct deposit means. At 308, the user's income designation can be done with each deposit or, at 309 the designation can be performed automatically based on rules 311 established by the example system. The means for both approaches are used as contract workers may have both regular and irregular sources of taxable income, hence the need to continue deposit review even after a particular automated rule is established. As shown by the dotted line 310 across the top of the figure, once a particular payer is identified as providing taxable income (e.g., by the user using the user computing device), future deposits may be automatically designated under the rule as taxable income without interaction with the user. The example process may also be performed for expenses, and at 312 the income and expenses data may then be stored.

Still referring to FIG. 3, at 314, recommended tax set-aside for each taxable income payment is calculated using a series of steps that are unique process discussed above. Included in the processing is the variable value in the user's tax set-aside account, the projected annual income (e.g., calculated based on a daily period), the user's stored tax filing information, amount of the new deposit designated as taxable income, and in some cases amount of expenses designated. At 315, the user 102 may decide how much of the recommendation for the tax set-aside may be actually placed in the tax set-aside account, at which point the value maybe moved (at 316). Thereafter, at reference 317 the example system may store the information, and present the user's progress for the current tax year.

At 318, the example system notifies the user of periodic estimated tax payment due dates. At 319 the user may decide to make a payment, and at 320 in some example systems automatically makes payments directly to the revenue collection agency. The process then starts anew each time the user is paid (at 306).

Part F—Status Module 220

Returning briefly to FIG. 2, in order to keep the user 102 apprised of tax set-aside goals, the example systems and methods update a user interface with current statistics and charts that depict their tax set-aside values compared to the current target as projected by the unique method. Set aside charts depict both the current percentage set aside as well as an indication of how the user is tracking to goal based on time of the year. The user may have saved 50% of their projected tax burden, but 90% of the year may have already transpired and an indication of their schedule failure needs to be shown as well.

Example User Interfaces

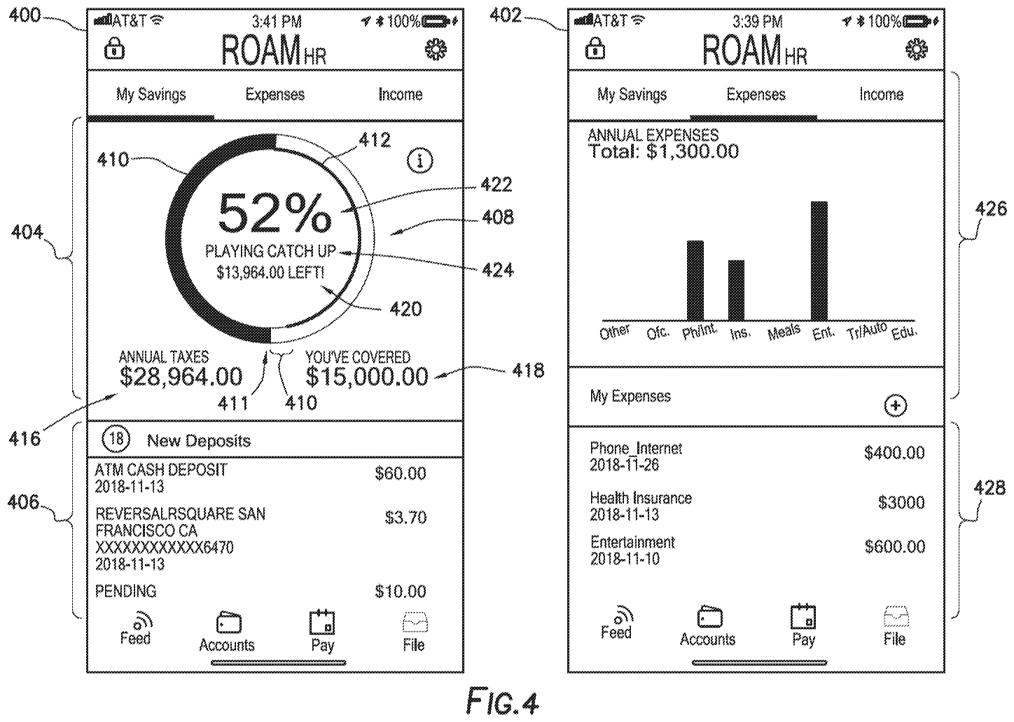

FIG. 4 shows example user interfaces in accordance with at least some embodiments. In particular, FIG. 4 shows a status screen 400 on the left that shows an example status of the user's periodic estimated tax payments and tax set-aside values, and an example expense screen 402 on the right showing categorizations of expenses previously designated as deductible business expenses. In particular, the status screen 400 is divided into a notification area 404 and data area 406. Within the data area 406 are shown various deposits as identified by the system, including a designation in this example that there 18 new deposits in that categorization. Within the notification area 404 resides graph that imparts information regarding the user's tax considerations. In particular, the notification area 404 includes a graphic 408 that includes several pieces of information. The graphic 408 is illustratively shown as a circle, but any suitable shape may be used (e.g., a square if the period is tax quarters, octagon if the period is eighths of the tax year). The outer diameter of the graphic 408 graphically imparts to the viewer how much has been paid in estimated periodic tax payments combined with the value of the user's tax set-aside account by thicker line or thicker bar 410 (hereafter payment bar 410). In particular, for the particular point in time shown, the circumference of the example circle represents estimated annual tax burden, and the circumferential length of the payment bar 410 (e.g., as measured from starting point 411) shows how much of that estimated annual tax burden has been covered (e.g., the sum of the estimated period tax payments made and the value in the user tax set-aside account). For each new deposit designated as taxable income, and thus each estimated annual tax burden, the scale (circumferential distance around the example circle) may change.

The outer diameter of the graphic 408 also graphically imparts to the viewer an indication of completed days within the current tax year (in relation to the total days within the current tax year) by thinner line or thinner bar 412 (hereafter percent bar 412). In particular, for the particular point in time shown and with respect to the percent bar 412, the circumference of the example circle also represents total number of days within the current tax year, and the circumferential length of the percent bar 410 (e.g., as measured from starting point 411) shows how much of the current tax year has been completed. Alternatively, the circumference of the example circle could represent percentage completion of the tax year (e.g., starting point 411 represents both 0% and 100%), and the circumferential length of the percent bar 410 (e.g., as measured from starting point 411) shows the percentage completion.

As shown the payment bar 410 and the percent bar 412 at least partially abut each other, and each line at least partially extend around the shape of the graphic, illustratively a circle. While the percent bar 412 is shown as the thinner line or thinner bar, the relative thicknesses may be swapped. Moreover, while the percent bar 412 is shown as the inner-most bar, the locations as between the percent bar 412 and the payment bar 410 may be swapped. When the user is fully only track in making estimated periodic tax payments and setting aside appropriate amounts in the tax set-aside account, the circumferential length of the payment bar 410 and the percentage bar 412 will be equal. When the user is fully behind in making estimated periodic tax payments and setting aside appropriate amounts in the tax set-aside account (as is the case for status screen 400), the circumferential length of the payment bar 410 will be shorting than the circumferential length of the percentage bar 412. And finally, when the user is ahead in making estimated periodic tax payments and setting aside appropriate amounts in the tax set-aside account, the circumferential length of the payment bar 410 will be longer than the circumferential length of the percentage bar 412.

Putting aside the example values (discussed more below), the graphic immediately imparts macro-sense information to the user. For example, the viewer can quickly get a sense of date within the current tax year based on: the circumferential length of the percent bar 412; and/or the circumferential length gap 414. Here, the viewer sees the tax year is nearly complete. Moreover, the example graphic immediately imparts that the user behind (e.g., playing catch up) when it comes to paying and/or setting aside money for payment of taxes.

Turning to the example values in the notification area 404, for the latest deposits designated as taxable income, the user's estimated annual tax burden will be $28,964 as shown by text 416. The notification area 404 further shows the total of the user's estimated periodic tax payments and value within the user's tax set-aside account is $15,000 in this example, as shown by text 418. The total circumferential length of the payment bar 410 graphically shows that the user has covered $15,000 (and again the scale of the full circumference is $28,964 at the point in time shown). And the difference in length between the payment bar 410 and the percent bar 412 shows that the user is behind.

The interior area 420 of the example graphic 408 also conveys information to the user in a form that easily understandable on a small screen of a user computing device, such as a mobile device. In particular, the interior area 420 indicates, by percentage text 422, how much user is behind (or ahead) with respect to tax payments and set-asides for the current period within the current tax year. In the example of status screen 400, the user has only paid or set aside 52% of the total tax burden year-to-date. Additionally, the alert text 424 conveys to the user, in a macro-sense, where the user stands from a tax perspective. In the example status screen 400, the user is “PLAYING CATCH UP.” However, many other alert text 424 may be used to quickly and efficiently convey to the user the status of the tax considerations. For example, the alert text 424 may include: “Surplus,” meaning the total of the user's estimated periodic tax payments and value within the user's tax set-aside account is more than the projected tax burden for the current period, and that suggested values for tax set-aside (or portions thereof) may be optional; “Equal,” meaning the total of the user's estimated periodic tax payments and value within the user's tax set-aside account is equal to the projected tax burden for the current period; “OK” or “DOING GREAT” meaning the total of the user's estimated periodic tax payments and value within the user's tax set-aside account is less than 5% behind the projected tax burden for the current period; “Warning,” meaning the total of the user's estimated periodic tax payments and value within the user's tax set-aside account is more than 5% but less than 25% behind the projected tax burden for the current period; and “Severe” or “Playing Catch Up,” meaning the total of the user's estimated periodic tax payments and value within the user's tax set-aside account is more than 25% behind the projected tax burden for the current period. Other wording for alert text 424, and other thresholds, may be used.

The data that underlies the example graphic 408 is duplicative, or calculated similarly, to the various embodiments discussed above, including periods of any suitable length. If the example period is daily, for each new deposit designated as taxable income the example system calculates a new income value by summing the new deposit and all previous deposits indicated as taxable income. Next, the system project an annual income value based on the new income value and an indication of date within the current tax year. In some cases, and average daily income is determined. From the average daily income the example system projects an annual income (e.g., the average daily income multiplied by total days of the current tax year), and with the annual income the example system projects an annual tax burden. The annual tax burden may then projected to a daily tax burden (e.g., annual tax burden divided by number of days the current tax year), and a year-to-date tax burden may be calculated as the daily tax burden multiplied by the number of days into the current tax year.

The system creates the payment bar 410 based on the sum of the previous tax payments for the current tax year and the value in the user's tax set-aside account (hereafter just Sum). The system created the percent bar 412 based on the date within the current tax year. The percentage text 422 may be calculated as the Sum divided the year-to-date tax burden multiplied by 100. The alert text 424 may be selected based on the value used from the percentage text 422.

The separated tax set-aside account implemented as part of the example system serves two example purposes. First, the tax set-aside account removes the dedicated amount from the user's primary account and thus primary cash flow. Secondly, the tax set-aside account enables the tax set-aside value to be an active part of the recommendation engine. The value of the tax set-aside account in tandem with the user's overall status thus influences the amount of recommended tax set-aside. Therefore, if the user borrows from the tax set-aside account for an emergency, the overall status may change (e.g., from “Equal” to “Warning”). The change in status in the alert text 424, and corresponding changes to the payment bar 410 and remaining bar 412, changes the parameters of the tax set-aside recommendations in an effort to get the user caught up and back on track. When the user receives a new income deposit, the recommended tax set-aside will be higher, thus having the user pay back the tax set-aside account.

Still referring to FIG. 4, the example expense screen 402 is divided into a notification area 426 and data area 428. Within the data area 404 are shown various deposits as identified by the system, including a designation in this example that there 18 new deposits that categorization. Within the notification area 404 resides graph that visually imparts information regarding various example categories of expenses. That is, not have certain expenses as deductible business expenses (e.g., by the user, or through crows-sourced designation), but also those expenses have been categorized to aid the user/viewer in understanding the magnitude of each category of expenses. The example data area 428 provides data regarding specific expenses summarized by category.

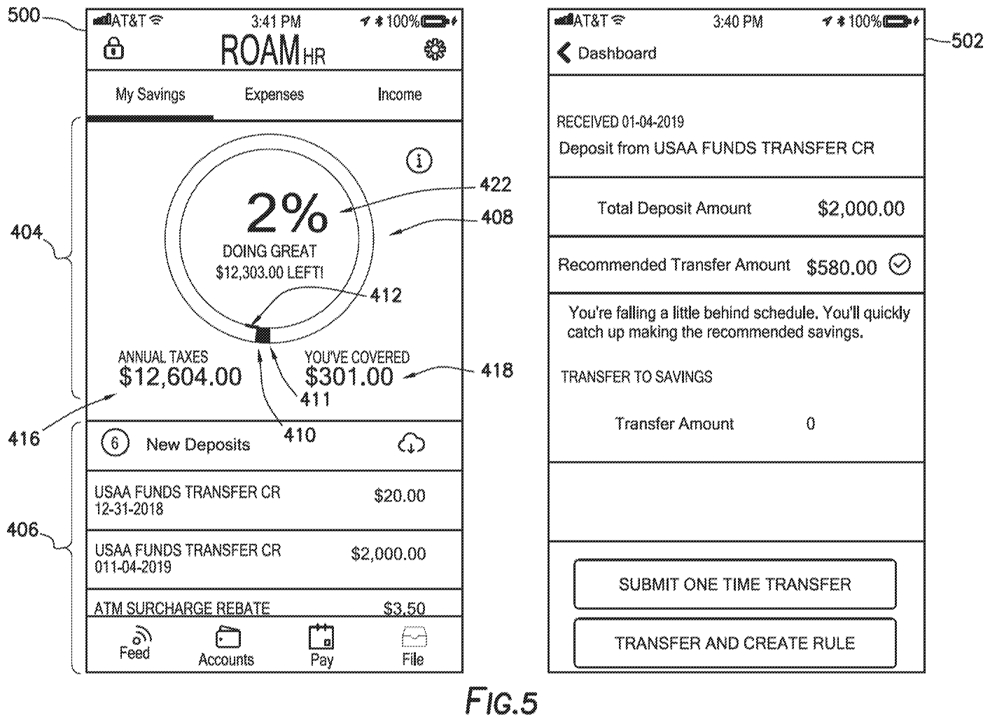

FIG. 5 shows example user interfaces in accordance with at least some embodiments. In particular, FIG. 5 shows a status screen 500 on the left that shows an example status of the user's periodic estimated tax payments and tax set-aside values (different than FIG. 4), and an example set-aside screen 502 on the right showing the system recommending a tax set-aside value based on a new deposit designated as taxable income.

In particular, as before the status screen 500 is divided into a notification area 404 and data area 406. Within the data area 406 are shown various deposits as identified by the system, including a designation in this example that there 6 new deposits in that categorization. Within the notification area 404 resides graphic 408, again illustratively shown as a circle. The outer diameter of the graphic 408 graphically imparts to the viewer how much has been paid in estimated periodic tax payments combined with the value of the user's tax set-aside account by payment bar 410. The outer diameter of the graphic 408 also graphically imparts to the viewer an indication of completed days within the current tax year by percent bar 412. Because in the example of FIG. 5 the current tax year is relatively new, the percent bar 412 is short (or stated oppositely the gap (not specifically numbered) is very long).

In the example notification area 404 in FIG. 5, with the latest deposits designated as taxable income, the user's estimated annual tax burden will be $12,604 as shown by text 416. The notification area 404 further shows the total of the user's estimated periodic tax payments and value within the user's tax set-aside account is $301 in this example, as shown by text 418. The total circumferential length of the payment bar 410 graphically shows that the user has covered $301 (and the scale of the full circumference is $12,604 at the point in time shown). The difference in length between the payment bar 410 shows that the user is behind, but not significantly behind given the point in time within the tax year. In fact, as shown by the percent text 422, the user is only 2% behind for the current tax year, which makes the alert text 424 designation as “Doing Great.” It is noted that the information conveyed in the notification area 404 does not necessarily include considerations of the new deposits indicated in the data area 406.

Still referring to FIG. 5, and particularly the set-aside screen 502. In the example set-aside screen 502 shown, a new deposit has been designated as taxable income. Here the new deposit is for $2000. Using the methods previously described, the example system recommends a tax set-aside value, in the example situation a tax set-aside value of $580. The user may then select an actual amount to be set aside, and either trigger a one-time transfer, or create a rule and transfer (e.g., the rule being always transfer the recommended tax set-aside amount).

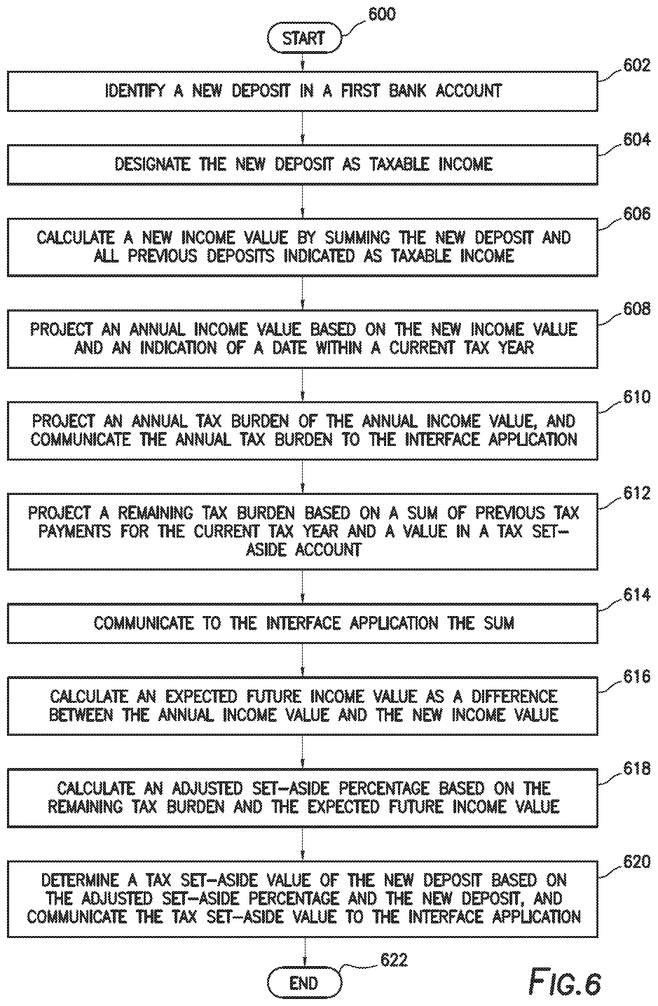

FIG. 6 shows a method in accordance with at least some embodiments. In particular, the method starts (600); identify a new deposit in a first bank account (602); designate the new deposit as taxable income (604); calculate a new income value by summing the new deposit and all previous deposits indicated as taxable income (606); project an annual income value based on the new income value and an indication of a date within a current tax year (608); project an annual tax burden of the annual income value, and communicate the annual tax burden to the interface application (610); project a remaining tax burden based on a sum of previous tax payments for the current tax year and a value in a tax set-aside account (612); communicate to the interface application the sum (614); calculate an expected future income value as a difference between the annual income value and the new income value (616); calculate an adjusted set-aside percentage based on the remaining tax burden and the expected future income value (618); and determine a tax set-aside value of the new deposit based on the adjusted set-aside percentage and the new deposit, and communicate the tax set-aside value to the interface application (620). Thereafter, the method ends (622), to be restarted on the next deposit designated as taxable income.

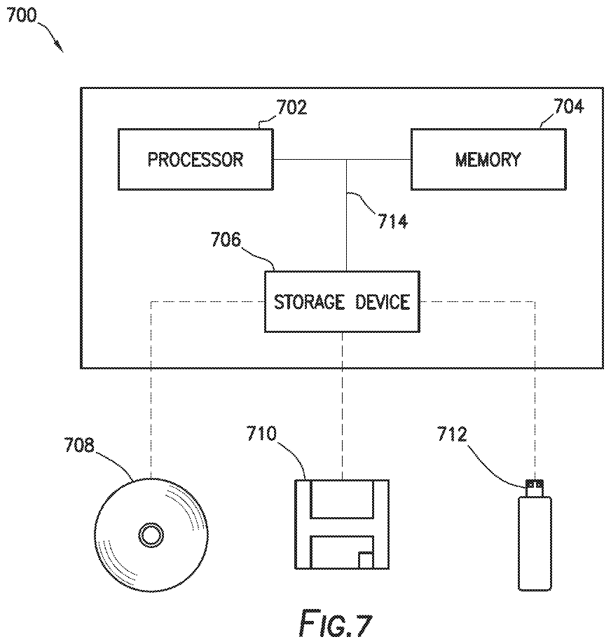

FIG. 7 shows a computer system in accordance with at least some embodiments. The computer system 700 is an example of the user computing device and the tax calculation computer. The example computer system 700 comprises a processor 702 coupled to a memory 704 and a storage system or long term storage device 706. The processor 702 may be any currently available or after-developed processor, or group of processors. The memory 704 may be random access memory (RAM) which forms the working memory for the processor 702. In some cases, data and programs may be copied from the storage device 706 to the memory 704 as part of the operation of the computer system 700.

The long term storage device 706 is a device or devices that implement non-volatile long-term storage, which may also be referred to as a non-transitory computer-readable media. In some cases, the long term storage device is a hard drive or solid state drive, but other examples include optical discs 708, “floppy” disks 710, and flash memory devices 712. The various programs used to implement the programmatic aspects discussed may thus be stored on the long term storage device 706, and executed by the processor 702. Relatedly, creation of the new recording of the various embodiments may be implemented by the processor 702 and communicated to the storage device 706 (including the example optical disc 708, floppy disk 710, or flash memory device 712 or magnetic tape) by way of a telemetry channel 714.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system comprising:
an interface application configured to execute on a mobile computing device;
a server communicatively coupled to the interface application, the server located at least one mile from the mobile computing device, and at least a portion of the communicative coupling between the server and the interface application being wireless;
the server configured to:
identify a new deposit in a first bank account;
designate the new deposit as taxable income;
calculate a new income value by summing the new deposit and all previous deposits indicated as taxable income;
project an annual income value based on the new income value and an indication of a date within a current tax year;
project an annual tax burden of the annual income value, and communicate the annual tax burden to the interface application;
project a remaining tax burden based on a sum of previous tax payments for the current tax year and a value in a tax set-aside account;
communicate to the interface application the sum;
calculate an expected future income value as a difference between the annual income value and the new income value;
calculate an adjusted set-aside percentage based on the remaining tax burden and the expected future income value; and
determine a tax set-aside value of the new deposit based on the adjusted set-aside percentage and the new deposit, and communicate the tax set-aside value to the interface application;
the interface application configured to:
generate a graphic on a screen of the mobile computing device that graphically illustrates the sum;
generate a graphic on the screen of the mobile computing device that graphically illustrates completed days within the current tax year; and
display the tax set-aside value on the screen of the mobile computing device.

2. The system of claim 1 wherein when the interface application generates the graphic that illustrates the sum and when the interface application generates the graphic that illustrates completed days within the current tax year, the interface application is configured to:
generate a first line with a first length starting at a starting point, the first length indicative of sum; and
generate a second line with a second length starting at the starting point, the second line at least partially abutting the first line, and the second length indicative of completed days within the current tax year;
the first line and the second line extending at last partially around a shape.

3. The system of claim 1 wherein when the interface application generates the graphic that illustrates the sum and when the interface application generates the graphic that illustrates completed days within the current tax year, the interface application is configured to:
generate a first line with a first width and a first length starting at a starting point, the first line extending at least partially around a circumference of a circle; and
generate a second line with a second width and a second length starting at the starting point, the second line extending at least partially around the circumference of the circle;
the second line at least partially abutting the first line, and the first width greater than the second width.

4. A system comprising:
a first computer configured to interface with a user;
a second computer communicatively coupled to the first computer, the second computer distinct from the first computer, the second computer configured to:
identify a new deposit in a first bank account;
designate the new deposit as taxable income;
calculate a new income value by summing the new deposit and all previous deposits indicated as taxable income;
project an annual income value based on the new income value and an indication of date within a current tax year;
project an annual tax burden of the annual income value;
project a remaining tax burden based on a sum of previous tax payments for the current tax year and a value in a tax set-aside account;
calculate an expected future income value as a difference between the annual income value and the new income value;
calculate an adjusted set-aside percentage based on the remaining tax burden and the expected future income value; and
recommend to the user a tax set-aside value of the new deposit based on the adjusted set-aside percentage and the new deposit.

5. The system of claim 4 wherein when the system projects the annual income value, the second computer is configured to:
calculate an average periodic income using the new income value and the indication of date within the current tax year; and
project the annual income value based on the average periodic income and a total number of periods.

6. The system of claim 4 wherein when the second computer projects the annual income value, the second computer configured to:
project an average daily income value using the new income value and the indication of date within the current tax year; and
multiply the average daily income value by a number of completed days within the current tax year.

7. The system of claim 6 further comprising:
wherein the second computer is further configured to receive an estimated annual income value from the user, the receipt of the estimated annual income value from the first computer; and
wherein when the second computer projects the annual income value, the second computer is further configured to override the annual income value in whole or in part with the estimated annual income value.

8. The system of claim 6 wherein, prior to when the second computer projects the annual tax burden, the second computer system is further configured to reduce the annual income value by expenses identified within the first bank account of the user.

9. The system of claim 4 wherein when the second computer identifies the new deposit in the first bank account, the second computer is further configured to:
receive login credentials to the first bank account at a bank of the user, the receipt from the first computer;
store the login credentials as an encrypted token in a database; and
use the encrypted token to access a third party service that acts as an intermediary to the first bank account.

10. The system of claim 4 wherein when the second computer designates the new deposit as taxable income, the second computer is further configured to:
generate transaction rules based on identity of entities previously transferring taxable income to the first bank account;
identify the deposits to the first bank account; and with each deposit;
designate the new deposit as taxable income using the transaction rules.

11. The system of claim 4 wherein when the second computer designates the new deposit as taxable income, the second computer is further configured to:
generate transaction rules based on identity of entities previously transferring taxable income to bank accounts of a plurality of users;
identify deposits to the first bank account; and with each deposit,
designate the new deposit as taxable income using the transaction rules.

12. The system of claim 4 wherein when the second computer designates the new deposit as taxable income, the second computer is further configured to:
send an alert to a mobile application running on the first computer; and
receive from the first computer an indication of the designation of the new deposit as taxable income.

13. The system of claim 4 wherein when the second computer designates the new deposit as taxable income, the second computer is further configured to:
read data related to the new deposit that identifies a first entity that transferred the funds to the first bank account;
access a database of entities previously identified as transferring taxable income; and
find a match between the first entity and an entry in the database of entities previously identified as transferring taxable income.

14. The system of claim 13 wherein when the second computer accesses the database of entities previously identified as transferring taxable income, the second computer is further configured to access the database of entities previously identified by the user of the first bank account as transferring taxable income.

15. The system of claim 13 wherein when the second computer accesses the database of entities previously identified as transferring taxable income, the second computer is further configured to access a database of entities previously identified by users of other accounts as transferring taxable income.

16. The system of claim 4 wherein when the second computer designates the new deposit as taxable income, the second computer is further configured to receive information directly from an entity that provided the new deposit that indicates the new deposit as taxable income.

17. The system of claim 4 wherein the first computer is a mobile phone with internet access.

18. The system of claim 4 wherein the second computer is a computer system of a cloud-based service.

19. A computer-implemented method comprising:
identifying a new deposit in a first bank account;
designating the new deposit as taxable income;
calculating a new income value by summing the new deposit and all previous deposits indicated as taxable income;
projecting an annual income value based on the new income value and an indication of date within a current tax year;
projecting an annual tax burden of the annual income value;
projecting a remaining tax burden based on a sum of previous tax payments for the current tax year and a value in a tax set-aside account;
calculating an expected future income value as a difference between the annual income value and the new income value;
calculating an adjusted set-aside percentage based on the remaining tax burden and the expected future income value; and
recommending to a user a tax set-aside value of the new deposit based on the adjusted set-aside percentage and the new deposit.

20. The computer-implemented method of claim 19 wherein, prior to projecting the annual tax burden, the method further comprises reducing the annual income value by expenses identified with the first bank account of the user.

21. The computer-implemented method of claim 19 wherein projecting the annual income value further comprises:
calculating an average periodic income using the new income value and the indication of date within the current tax year; and
projecting the annual income value based on the average periodic income and a total number of periods.

22. The computer-implemented method of claim 21 further comprising:
receiving an estimated annual income from the user;
wherein projecting the annual income value further comprises overriding the annual income value in whole or in part with the estimated annual income.

23. The computer-implemented method of claim 21 wherein, prior to projecting the annual tax burden, the method further comprises reducing the annual income value by expenses identified within the first bank account.

24. The computer-implemented method of claim 19 wherein identifying the new deposit in the first bank account further comprises:
receive login credentials to the first bank account;
storing the login credentials as an encrypted token in a database; and
using the encrypted token to access a third party service that acts as an intermediary to the first bank account.

25. The computer-implemented method of claim 19 wherein designating the new deposit as taxable income further comprises:
generating transaction rules based on identity of entities previously transferring taxable income to the first bank account;
identifying the deposits to the first bank account; and with each deposit,
designating the new deposit as taxable income using the transaction rules.

26. The computer-implemented method of claim 19 wherein designating the new deposit as taxable income further comprises:
generating transaction rules based on identity of entities previously transferring taxable income to bank accounts of a plurality of users;
identifying deposits to the first bank account; and with each deposit,
designating the new deposit as taxable income using the transaction rules.

27. The computer-implemented method of claim 19 wherein designating the new deposit as taxable income further comprises:
sending an alert to a mobile application running on a mobile computing device; and
receiving from the mobile computing device an indication of the status designation of the new deposit as taxable income.

28. The computer-implemented method of claim 19 wherein designating the new deposit as taxable income further comprises:
reading data related to the new deposit that identifies a first entity that transferred the funds to the first bank account;
accessing a database of entities previously identified as transferring taxable income; and
finding a match between the first entity and an entry in the database of entities previously identified as transferring taxable income.

29. The computer-implemented method of claim 28 wherein accessing the database of entities previously identified as transferring taxable income further comprises accessing the database of entities previously identified by the user of the first bank account as transferring taxable income.

30. The computer-implemented method of claim 28 wherein accessing the database of entities previously identified as transferring taxable income further comprises accessing a database of entities previously identified by users of other accounts as transferring taxable income.

31. The computer-implemented method of claim 19 wherein designating the new deposit as taxable income further comprises receiving information directly from an entity that provided the new deposit that indicates the new deposit as taxable income.
